(19) United States
(12) Patent Application Publication
(10) Pub. No.: US 2010/0146478 A1
(43) Pub. Date: Jun. 10, 2010

(54) MULTI-LAYERED STORAGE AND MANAGEMENT OF SOFTWARE COMPONENTS

(75) Inventors: James Scott Head, Bellevue, WA (US); Humberto Lezama Guadarrama, Bellevue, WA (US); Elliot Stephenson Lewis, Seattle, WA (US); Christian J. Betrisey, Bellevue, WA (US); Xiaodong La, Bellevue, WA (US); Ajith K. Gande, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/331,451

(22) Filed: Dec. 10, 2008

(51) Int. Cl. G06F 9/44

(52) U.S. Cl. 717/101; 717/120

(57) ABSTRACT

Architecture that employs multi-row entities to store solution components using columns, properties and logic that track solution components by storing different versions (states) of the component into multiple rows. Component modification includes adding and/or modifying multiple rows, thereby facilitating support operations such as uninstall by retaining versions information of the same component. A master solution component table tracks all the root components of a solution, and logic implemented in code traverses the root nodes to discover all children nodes to efficiently track all components of a solution. The logical states of protected and unprotected for solution allow customers to develop multiple solutions on the same system (organization), protect a solution, and build composite applications with multiple solutions involved (layering of solutions). Multi-row storage facilitates the storage of the component definition and associated solution.

### BACKGROUND

Application developers are constrained by the mechanisms currently offered by development architectures. Components are developed in an ad hoc manner and the components are stored with no apparent design in mind. Moreover, there were no means to group the component together. Consequently, operations such and install, uninstall of solutions are not supported natively. Software vendor partners and customers are left to develop expensive custom tools to manage their applications (solutions). Furthermore, where a software publisher managed to create a custom installer, once deployed into the customer environment there are no restrictions that prevent the customer from replicating the publisher's solution. In other words, the customer can export solution components thereby representing a threat to the intellectual property rights of the software publisher. Additionally, for intellectual property reasons, once a solution has been developed and distributed the software publisher expects the solution not to be modified or replicated without authorization.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture includes a complete framework and tools that support a notion of “solutions”, which is a bundle of components (e.g., data, processes, user interface changes, etc.) built on top of a management platform (e.g., customer relations), the bundle treated as a single unit of software. The architecture employs techniques to store, group, manage, protect, and transport solution components. Each individual technique finds applicability to a wide variety of platforms and frameworks.

For example, when applied to a customer relations management (CRM) environment, the grouping of the components into a logical bundle is part of the equation. The actions/transitions such as install, uninstall/rollback, and upgrade, for example, of the components as well as transport (packaging) are provided. Additionally, for intellectual property reasons, once a solution has been developed and distributed the software publisher can trust that the solution will not be modified or replicated without authorization.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented software solution development system in accordance with the disclosed architecture.

FIG. 2 illustrates a high level flow diagram and components for developing solutions for a solution aware platform using solution aware tools and APIs.

FIG. 3 illustrates an exemplary logical architecture of the solution aware platform.

FIG. 4 illustrates a diagram of solutions creation and packaging.

FIG. 5 illustrates an exemplary multi-row table for a solution component.

FIG. 6A illustrates an exemplary state diagram for transition management.

FIG. 6B illustrates the system component portion of the state diagram.

FIG. 7 illustrates a method of developing software solutions.

FIG. 8 illustrates a method of managing a solution.

FIG. 9 illustrates a block diagram of a computing system operable to develop solutions and run solutions on a platform in accordance with the disclosed architecture.

FIG. 10 illustrates a schematic block diagram of a computing environment that facilitates solution development and operation on a platform.

### DETAILED DESCRIPTION

The disclosed architecture employs multi-row entities to store solution components using columns, properties and logic that track solution components by storing different versions (states) of the component into multiple rows. Component modification includes adding and/or modifying multiple rows, thereby facilitating support operations such as uninstall by retaining versions information of the same component. A master solution component table tracks all the root components of a solution, and logic implemented in code traverses the root nodes to discover all children nodes to efficiently track all components of a solution.

The logical states of protected and unprotected for solution allow customers to develop multiple solutions on the same system (organization), protect a solution, and build composite applications with multiple solutions involved (layering of solutions). Multi-row storage facilitates the storage of the component definition and associated solution using multiple rows.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

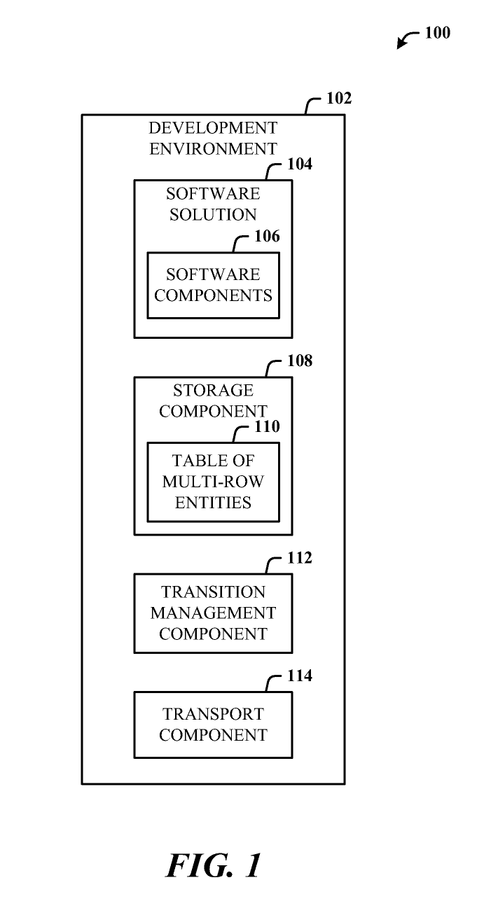

FIG. 1 illustrates a computer-implemented software solution development system 100 in accordance with the disclosed architecture. The system 100 can include a development environment 102 for developing a software solution 104 as a logical bundle of software components 106. A storage component 108 of the environment 102 stores an association of a component definition with the solution 104 as multi-row entities 110. A transition management component 112 of the environment 102 manages behavior changes in the software components 106 based on state transition definitions.

The storage component 108 stores state of the components 106 into multiple rows and tracks component modifications by adding new rows or modifying existing rows. The storage component 108 also tracks root components of the solution 104 in a master solutions table. The transition management component 112 employs a state machine and state transition definitions to manage solution tables and modifies a transition definition in response to a change in behavior.

The transition management component 112 employs protected and unprotected logical modes for the solution 104. The development environment 102 facilitates the layering of an unprotected solution on top of a protected solution. The transition management component 112 includes an active solution that tracks changes made to system objects and changes performed on top of protected solutions. Moreover, the protected solution is prevented from being exported. The development environment 102 can also include a transport component 114 for exporting differences in modifications to the solution 104.

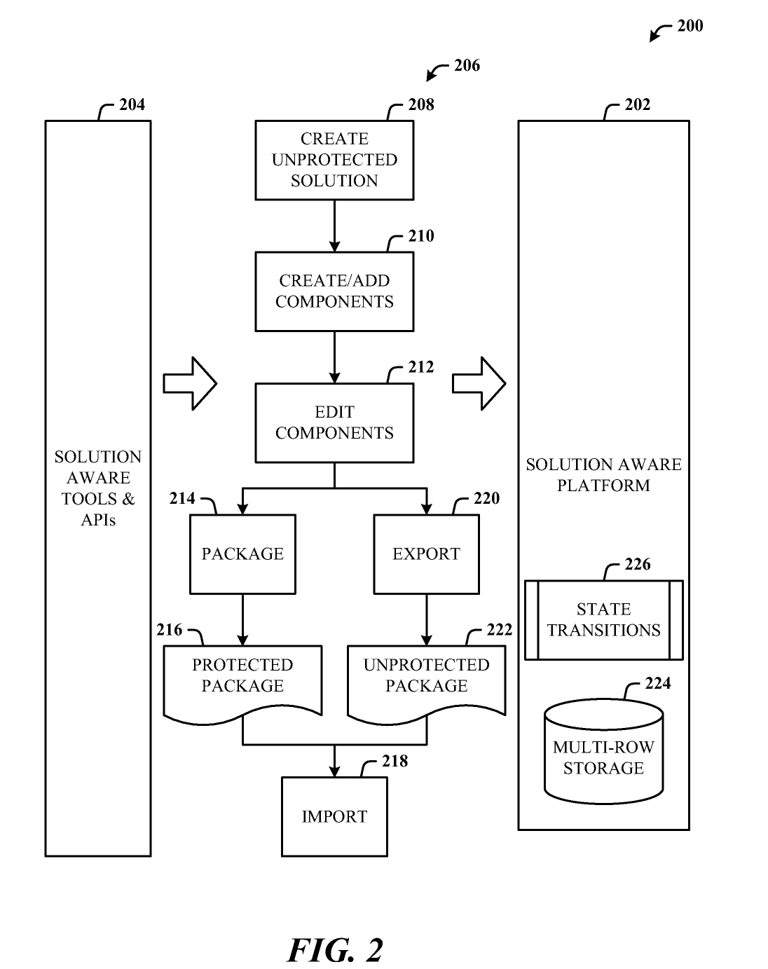

FIG. 2 illustrates a high level flow diagram 200 and components for developing solutions for a solution aware platform 202 using solution aware tools and APIs (application program interfaces) 204. The solution aware tools and APIs 204 include the development environment 102 of FIG. 1, for example. A process 206 facilitated by the tools and APIs 204 includes the creation of an unprotected solution (at 208). The unprotected solution can be accessed for creating and/or adding components (at 210). The created and/or added components can then be edited (at 212). After component creation, addition, and/or editing for the unprotected solution has completed, the unprotected solution can be packaged (at 214), which packaging converts the unprotected solution into a protected package (at 216). The protected solution can then be imported for use by the solution aware platform 202 (e.g., CRM) in the protected mode. Alternatively, after component creation, addition, and/or editing for the unprotected solution has completed, the unprotected solution can be exported (at 220) at an unprotected package (at 222). The packaged unprotected solution can then be imported for use by the solution aware platform 202.

The platform 202 then stores the solutions and solution components as multi-row storage 224 in tables (e.g., SQL-structured query language) for searching (e.g., child-parent nodes), version control (e.g., state), etc. Additionally, solution and component state is managed in the numerous tables using a state machine and state transition definitions that define state transitions 226.

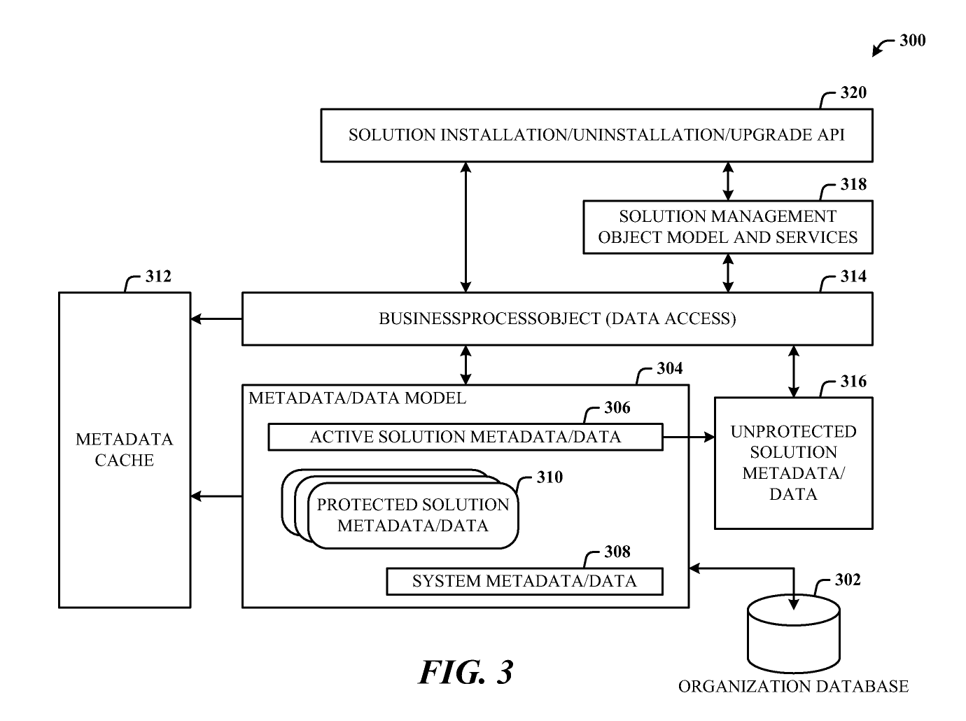

FIG. 3 illustrates an exemplary logical architecture 300 of the solution aware platform 202. The architecture 300 provides a consistent view of solution data and metadata in order for entities, services, and systems to behave as desired. This accomplished by allowing for multiple rows of a solution component to exist in an organization database 302.

The architecture 300 provides a consistent metadata/data model 304 that enables solution installation, upgrading, and uninstallation, as well as solution development, metadata sharing across organizations, metadata publishing and, clear and concise states for metadata and data. This allows for efficient views of the current state of the system, quick and easy retrieval of all solution components, well defined transitions from one state to another, and proper database constraints (e.g., foreign key constraints) to be maintained.

The metadata model is efficient, easy to access/update, and relatively to understand. Moreover, the architecture describes a solution entity, solution component, and a solution dependency as first class entities in the platform system (e.g., CRM).

The metadata/data model can include active solution metadata/data 306, system solution metadata/data 308 and protected solution metadata/data 310. A metadata cache 312 is solution aware in that it facilitates the sharing across organizations of system and protected solutions, for example.

There are four distinct solution types: system solution, active solution, protected solution, and unprotected Solution. Following is a description of each solution.

The system solution (only one system solution) solution consists of all out-of-the-box (OOB) components. This means that all metadata provisioned on installation belongs to the system solution. The system solution cannot be created, modified or deleted by the end user, but is more of a placeholder to identify OOB objects that can be shared by other solutions customizing the system.

The active solution (only one active solution) is similar to the system solution in that it also cannot be created, modified or deleted by the end user. This is because the active solution is a construct that is used to track all customizations done to system metadata/data 308 and protected solution metadata/data 310. The active solution is hidden from the end user and is used for administration of solution components within unprotected solutions. The active solution simplifies the view of data and metadata, by ensuring that there is not a different set of metadata/data for any given unprotected solution. The active solution also guarantees a consistent interface to the metadata and data throughout the system when more than one solution is being developed at a time, consistent in that all solutions being developed see the same set of customizations, as well as exporting the same customizations because the solutions are in effect working on the same objects even though in different unprotected solutions.

The protected solution (can be multiple protected solutions) is a logical grouping of components that can be installed, upgraded and uninstalled. The protected solution cannot be modified once installed into an organization. Note that it is not necessary to be able to view the exact components of the solution as defined on installation. It is sufficient to show a listing of what is in the solution and the current state of that data/metadata.

There is at least one unprotected solution (the default solution), and users have the ability to add more. An unprotected solution is a logical grouping of active solution components. When no solutions have been defined, any customization falls into the default solution, which is the unprotected solution that is defined by the system in order to catch all customizations that do not belong explicitly to any other unprotected solution.

When working in a solution editor, the user is working within a given solution. All customizations done within that context will be attributed to the working unprotected solution. Unprotected solutions can be created, updated, deleted (removing all customizations done in that solution), exported and imported. Unprotected solutions, unlike protected solutions, can be modified within an organization.

Generally, the system solution and protected solutions can be shared across organizations within the metadata cache 312. The system solution and the protected solution can be upgraded, which may or may not affect the working set of metadata/data. The system solution can be thought of as the base protected solution. The active solution can be thought of as the base unprotected solution. Protected solutions can only depend on other protected solutions.

A business process object 314 (BusinessProcessObject (Data Access)) interfaces to the metadata cache 312, the metadata/data model 304 and interacts with unprotected solution metadata/data 316. The business process object 314 can also interface to solution management object model and services 318 and a solution installation/uninstallation/upgrade API 320.

The solution management object model and services 318 include the structure for supporting solutions within the solutions aware platform. This includes the capability to create a publisher, a solution description, and associate components to the solution. Dependencies on other solutions can also be added. The solution management object model and services 318 can act independently of the metadata and data changes that support solution development and install/uninstall/upgrade.

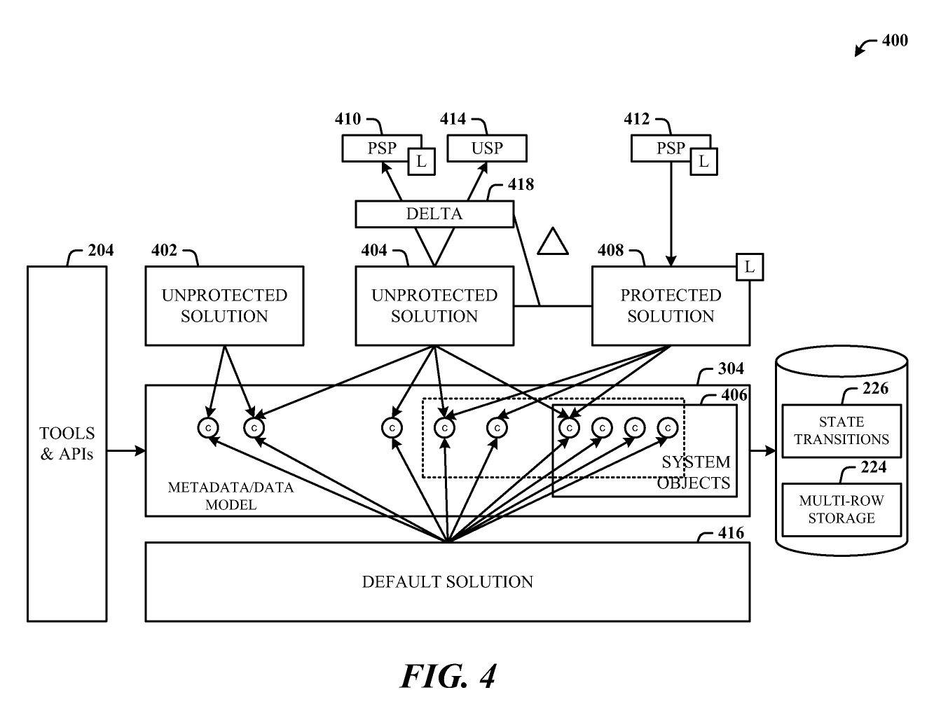

FIG. 4 illustrates a diagram 400 of solutions creation and packaging. To differentiate between a solution that is unlocked or in an unprotected logical mode (under development) and a solution that is locked (denoted by box with “L”) or in a protected logical mode. Unprotected solutions (402 and 404) can be customized by adding components to the solution by any customizer with the proper privileges. Users can only “create” solutions in unprotected mode.

All unprotected solutions see the same copy of “shared” objects. If two unprotected solutions (e.g., 402 and 404) modify the same object, then both solutions see the same data. This is accomplished by including an “active” solution (the active solution metadata/data 306 of FIG. 3) that keeps track of modification performed on all system objects 406, as well as changes performed on top of protected solutions (e.g., protected solution 408).

Protected solutions are locked, which means that no components (denoted by circle with “c”) can be added to the solution and components cannot be deleted from the solution. In another embodiment, the modification of components is also prevented.

As previously described, a protected solution is produced by “packaging” an unprotected solution. This is depicted by packaging the unprotected solution 404 into the protected solution package (PSP) 410. Additionally, the unprotected solution 404 can serve as the basis for an unprotected solution package (USP) 414. A system can obtain a protected solution package by importing the PSP 412. A protected solution is not allowed to be “exported”. This addresses intellectual property concerns of software publishers. Other implications for protected solutions are described herein below with respect to layering.

As indicated in the dotted box, an unprotected solution (e.g., unprotected solution 404) can reference components (circle with “c”) from protected solutions (e.g., protected solution 408), and add things on top of those protected components.

Solutions include not only metadata (e.g., object definitions—a definition of an entity or a definition of an attribute), but also other objects such as record security rows, or information such as settings or email samplings, for example. Thus, a solution is allowed to have both data and metadata as part of the bundle.

At any given point in time, users can perform customizations from within a solution. If no specific solution is selected, a default solution 416 will engage.

Put another way, users are presented with a unified “solution” concept for protected and unprotected solutions. The solution is a set of components (e.g., entities, attributes, relationships, workflows, reports) that provide a specific set of functionality on top of the core platform (e.g., CRM). Additionally, a solution contains a set of attributes that identify and configure the solution.

Customers and software vendors usually create two main types of solutions: vertical (a complete vertical market, e.g., HRM-human resource management) and horizontal (usually known as add-ins). At any given point in time, a solution can be in the unprotected state or the protected state. The unprotected state can be thought of as solution “projects” or solutions that are under development. Whenever customizations can be made in the context of a solution, that solution is considered to be unprotected. New solutions are created in this state. The protected state is created after an unprotected solution has been packaged and installed. No modifications can be performed in the context of the protected solution. Any changes to components that the protected solution has declared to be “customizable” can be performed from within an unprotected solution.

In an alternative embodiment, a partial solution can be obtained that contains only selected components. For example, if the user decides to export only a subset of components (e.g., some but not all entities) the solution is considered to be partial.

A solution component is constituent piece of the solution that can be used to extend the platform to achieve specific functionality. Some common components include entities, attributes, plug-ins, workflows, forms, etc. A non-customizable component is a component that once protected and installed, cannot be modified. An example is a “merged” attribute on an Account entity. A customizable component is a component that once protected and installed, can still be modified (but not deleted) by any solution. An example is the “Display Name” of the Account entity.

The delta block 418 indicates that only the differences (delta) in modifications performed to a customizable component are passed. An example is a software vendor solution that changes the Display Name of an Account from “Account” to “School”. When the software vendor solution package is generated, the redefinition of the entity is exported along with the rest of the vendor solution components. The solution package (e.g., PSP 410) is a group of files that include the solution definition along with all its components. In an alternative embodiment, a solution repository can be provided, which is a deployment wide container of solutions that can be deployed in multiple organizations.

A solution publisher is a user or vendor that develops solutions on top of the platform. In one embodiment, solution events can be implemented, which are a set of events for solutions (e.g., install, uninstall) for which vendors can include vendor handlers (e.g., plug-ins) in order to implement custom actions.

The default solution 416 is the “catch-all” solution that contains a reference to all unprotected components. OOB solutions are not customizable. An active solution is either a “draft” version or a “published” version of every object in the system, even when multiple solutions hold a reference to the same object.

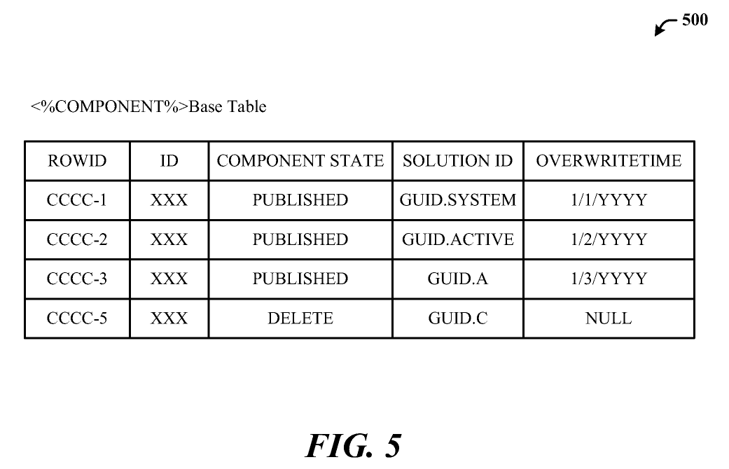

FIG. 5 illustrates an exemplary multi-row table 500 for a solution component. The table 500 is capable of storing and tracking solution components. Columns, properties, and logic are provided to track solution components by storing different versions (states) of the component into multiple rows. Whenever a component is modified, rows can be added and/or modified. This facilitates support operations such as “uninstall” since different “versions” of the same component are stored and tracked.

Additionally, a master solution component table tracks all the “root” components of a solution. Logic code can traverse the root nodes and discover all children nodes. The net effect is the efficient tracking of all the components of a solution. The table 500 illustrates the notion of multi-row entities.

The RowID is the unique primary key of this row. This column ensures there is a unique value that represents this row. The ID is the key used to access this component by other components and services in the system. The Component State represents the state of the row, whether it was last published, deleted, or unpublished in the current row. The SolutionID represents the solution that this component is related to. The SolutionID can either be the System Solution ID, the Active Solution ID, or any Protected Solution ID. The OverwriteTime refers to the time that this row was overwritten by another row with the same component ID. If the value is NULL, then this row is currently active.

Following is a multi-row component example showing the lifecycle of a solution component, starting from being installed, then updated, installing a solution on top, having a solution delete it, and finally, having one of the installed solutions uninstalled. There are more cases that can occur than what is described here.

The steps that the solution component will run through include 1) new installation of a platform with component ‘xxx’, 2) customization of component ‘xxx’ from the system solution, 3) installation of Protected Solution A, which customizes ‘xxx’, 4) creation of Unprotected Solution B, which creates an unpublished customization of component ‘xxx’, 5) installation of Protected Solution C, which deletes ‘xxx’, 6) uninstallation of the Protected Solution, which includes 6a) the uninstallation of Solution A and 6b) the uninstallation of Solution C. The full solution shows the inclusion of a SolutionComponents table and a Solution Table.

In step 1), on initial installation of the system, all components have a single row, marked as {Published, GUID.System} and no OverwriteTime.

<% COMPONENT %>Base Table

| RowID | D | ComponentState | SolutionID | OverwriteTime |
|---|---|---|---|---|
| 1111-1 | xxx | Published | GUID.System | NULL |

Three solutions (System, Active, and Default Solution) are defined upon installation.

SolutionInfo Table

| SolutionId | UniqueName | SolutionMode |
|---|---|---|
| GUID.System | System | Protected |
| GUID.Active | Active | Unprotected |
| GUID.Default | Default Solution | Unprotected |

On installation, the SolutionComponent table contains only the system solution rows.

SolutionComponent Table

| | | | |
|---|---|---|---|
| ID | SolutionID | ComponentType | ObjectID |

*contains all system solution rows*

In step 2), the customization of component ‘xxx’, the tables are shown after a user has customized component ‘xxx’ in no particular solution.

<% COMPONENT %>Base Table

| RowID | ID | ComponentType | SolutionID | OverwriteTime |
|---|---|---|---|---|
| 1111-1 | Xxx | Published | GUID.System | Jan. 1, 2008 |
| 1111-2 | Xxx | Published | GUID.Active | NULL |

After customizing data, no solutions are created because the default solution is used for all customizations that do not belong to a specific solution.

Solution Table

| SolutionId | UniqueName | SolutionMode |
|---|---|---|
| GUID.System | System | Protected |
| GUID.Active | Active | Unprotected |
| GUID.Default | Default Solution | Unprotected |

Once a component has been customized, a reference to that component is added to the SolutionComponent table.

SolutionComponent Table

| ID | SolutionID | ComponentType | ObjectID |
|---|---|---|---|
| 2222-1 | GUID.Default | Entity | xxx |

In step 3), installation of Protected Solution A which customizes ‘xxx’, when a new solution is installed, the old customization's OverwriteTime is updated and the new Solution row is used as the Production row.

<% COMPONENT %>Base Table

| RowID | ID | ComponentType | SolutionID | OverwriteTime |
|---|---|---|---|---|
| 1111-1 | xxx | Published | GUID.System | Jan. 1, 2008 |
| 1111-2 | xxx | Published | GUID.Active | Jan. 2, 2008 |
| 1111-3 | xxx | Published | GUID.A | NULL |

With the installation of a new solution, a new row is added to the Solution Table.

Solution Table

| SolutionId | UniqueName | SolutionMode |
|---|---|---|
| GUID.System | System | Protected |
| GUID.Active | Active | Unprotected |
| GUID.Default | Default Solution | Unprotected |
| GUID.A | Solution A | Protected |

The newly installed solution has all of its component references written to the SolutionComponent table. Even if a new solution is installed and overwrites a component, the reference for the default solution is kept to that component in the SolutionComponent table. This is so that upon an uninstallation rollback to the correct state can be performed.

SolutionComponent Table

| ID | SolutionID | ComponentType | ObjectID |
|---|---|---|---|
| 2222-1 | GUID.Default | Entity | xxx |
| 2222-2 | GUID.A | Entity | xxx |

In step 4), component ‘xxx’ is customized in Unprotected Solution B, creating a customizable solution—Solution B—performs an unpublished customization of this entity. The table entries are as follows. Note that the SolutionID does not reference Solution B explicitly.

<% COMPONENT %>Base Table

| RowID | ID | ComponentType | SolutionID | OverwriteTime |
|---|---|---|---|---|
| 1111-1 | xxx | Published | GUID.System | Jan. 1, 2008 |
| 1111-2 | xxx | Published | GUID.Active | Jan. 2, 2008 |
| 1111-3 | xxx | Published | GUID.A | NULL |
| 1111-4 | xxx | Unpublished | GUID.Active | NULL |

Solution B is added as a new row to the Solution table.

Solution Table

| SolutionId | UniqueName | SolutionMode |
|---|---|---|
| GUID.System | System | Protected |
| GUID.Active | Active | Unprotected |
| GUID.Default | Default Solution | Unprotected |
| GUID.A | Solution A | Protected |
| GUID.B | Solution B | Unprotected |

After Solution B is created, the unpublished customized component reference is added to the SolutionComponent table.

SolutionComponent Table

| ID | SolutionID | ComponentType | ObjectID |
|---|---|---|---|
| 2222-1 | GUID.Default | Entity | xxx |
| 2222-2 | GUID.A | Entity | xxx |
| 2222-3 | GUID.B | Entity | xxx |

In step 5), installation of Protected Solution C which deletes ‘xxx’, by now installing Solution C, which deletes this component, the older rows will have OverwriteTime's updated.

<% COMPONENT %>Base Table

| RowID | ID | ComponentType | SolutionID | OverwriteTime |
|---|---|---|---|---|
| 1111-1 | xxx | Published | GUID.System | Jan. 1, 2008 |
| 1111-2 | xxx | Published | GUID.Active | Jan. 2, 2008 |
| 1111-3 | xxx | Published | GUID.A | Jan. 3, 2008 |
| 1111-5 | xxx | Delete | GUID.C | NULL |

Installing Solution C adds a non-customizable solution to this table.

Solution Table

| SolutionId | UniqueName | SolutionMode |
|---|---|---|
| GUID.System | System | Protected |
| GUID.Active | Active | Unprotected |
| GUID.Default | Default Solution | Unprotected |
| GUID.A | Solution A | Protected |
| GUID.B | Solution B | Unprotected |
| GUID.C | Solution C | Protected |

Even though Solution C was installed, Solution B still has a reference to entity ‘xxx’. Note that if Solution B was exported in the current state Solution B includes a dependence on Solution C (i.e., Solution C has be installed for Solution B to be installed), and entity ‘xxx’ is not any different than the definition in Solution C.

SolutionComponent Table

| ID | SolutionID | ComponentType | ObjectID |
|---|---|---|---|
| 2222-1 | GUID.Default | Entity | xxx |
| 2222-2 | GUID.A | Entity | xxx |
| 2222-3 | GUID.B | Entity | xxx |
| 2222-4 | GUID.C | Entity | xxx |

In step 6a), Solution A can now be uninstalled without affecting the current metadata definition for this entity, but removing the prior customizations.

<% COMPONENT %>Base Table

| RowID | ID | ComponentType | SolutionID | OverwriteTime |
|---|---|---|---|---|
| 1111-1 | xxx | Published | GUID.System | Jan. 1, 2008 |
| 1111-2 | xxx | Published | GUID.Active | Jan. 2, 2008 |
| 1111-5 | xxx | Delete | GUID.C | NULL |

Uninstallation of Solution A deletes the row from the Solution Table.

Solution Table

| SolutionId | UniqueName | SolutionMode |
|---|---|---|
| GUID.System | System | Protected |
| GUID.Active | Active | Unprotected |
| GUID.Default | Default Solution | Unprotected |
| GUID.B | Solution B | Unprotected |
| GUID.C | Solution C | Protected |

Uninstalling Solution A has no effect on what Solution B contains.

SolutionComponent Table

| ID | SolutionID | ComponentType | ObjectID |
|---|---|---|---|
| 2222-1 | GUID.Default | Entity | xxx |
| 2222-3 | GUID.B | Entity | xxx |
| 2222-4 | GUID.C | Entity | xxx |

In step 6b, the uninstallation of Solution C instead of Solution A, if uninstalling Solution C instead, rollback is to the customizations performed by Solution B on entity ‘xxx’.

<% COMPONENT %>Base Table

| RowID | ID | ComponentType | SolutionID | OverwriteTime |
|---|---|---|---|---|
| 1111-1 | xxx | Published | GUID.System | Jan. 1, 2008 |
| 1111-2 | xxx | Published | GUID.Active | Jan. 2, 2008 |
| 1111-3 | xxx | Published | GUID.A | NULL |

Uninstalling of Solution C deletes the row from the Solution Table, just as if Solution A was uninstalled.

Solution Table

| SolutionId | UniqueName | SolutionMode |
|---|---|---|
| GUID.System | System | Protected |
| GUID.Active | Active | Unprotected |
| GUID.Default | Default Solution | Unprotected |
| GUID.A | Solution A | Protected |
| GUID.B | Solution B | Unprotected |

Regardless of which solution is uninstalled, Solution B keeps its reference to entity ‘xxx’.

SolutionComponent Table

| ID | SolutionID | ComponentType | ObjectID |
|---|---|---|---|
| 2222-1 | GUID.Default | Entity | xxx |
| 2222-2 | GUID.A | Entity | xxx |
| 2222-3 | GUID.B | Entity | xxx |

Transition management employs a state machine and many state transition definitions. This provided flexibility and extensibility in that any change in behavior can be accomplished by modifying the transition definitions. The following figures illustrate the main transitions.

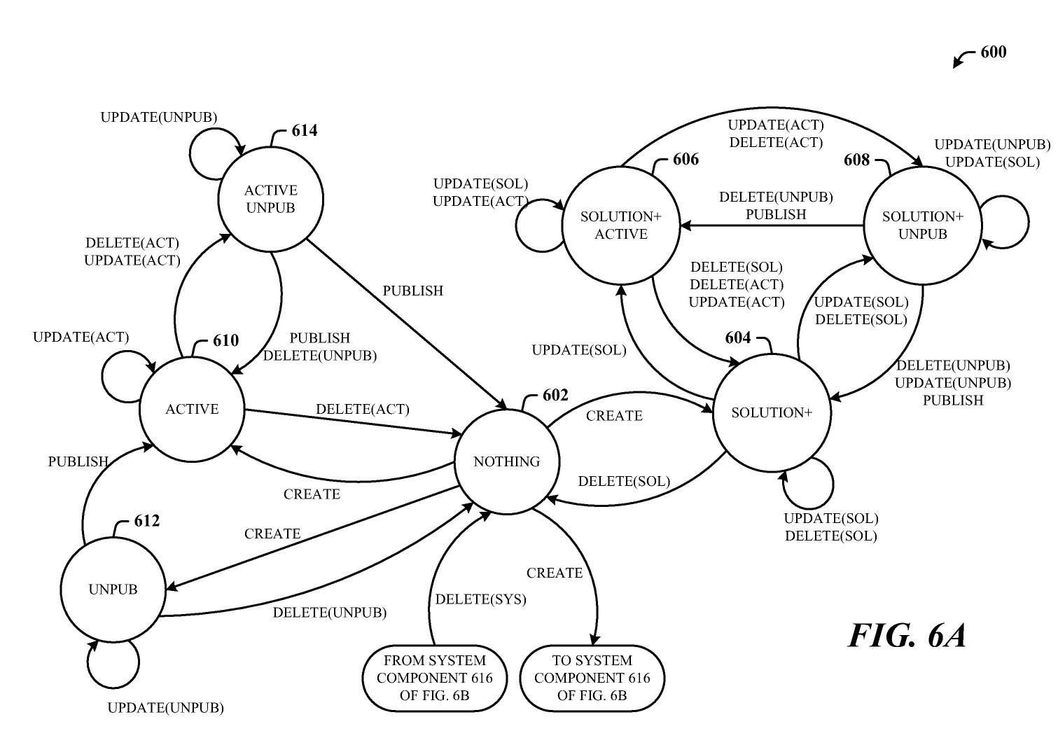

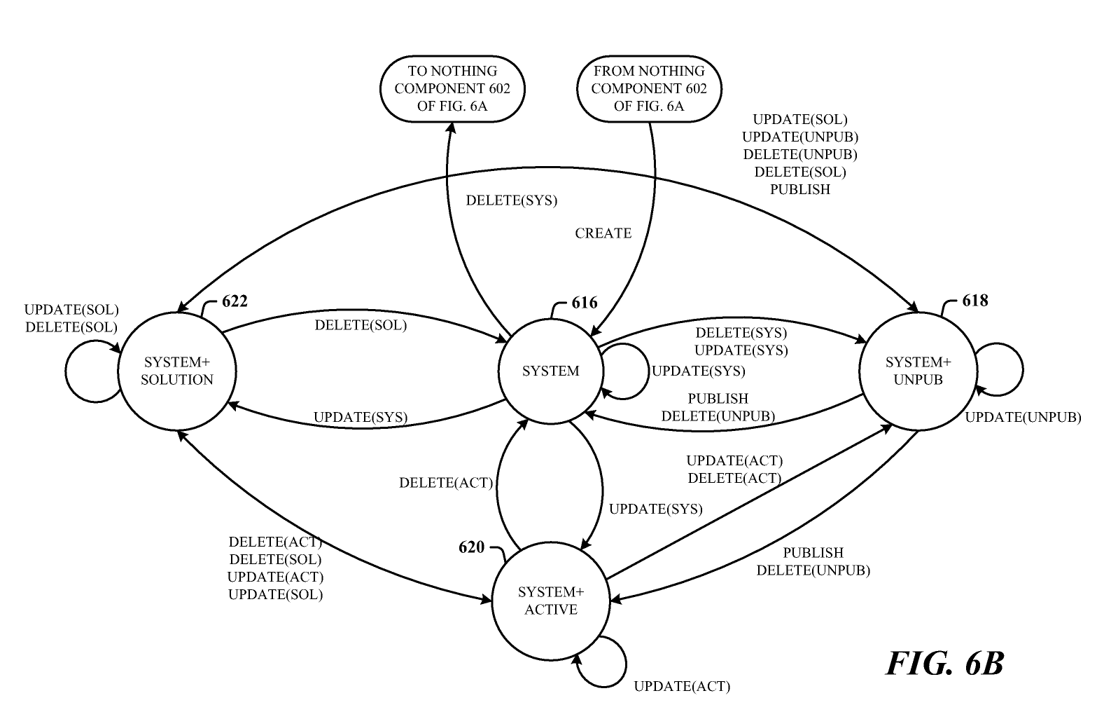

FIG. 6A illustrates an exemplary state diagram 600 for transition management. The state diagram 600 includes state transitions that grouped into three separate sections: a solutions section, system section, active section. A nothing state 602 represents that there is nothing representing the component and no component that exists. State can transition three ways from the nothing state 602: downward to become a system component (illustrated in FIG. 6B), up and right to become a solution component, or up and to the left to become an active component. The system components are created as components by the distribution vendor. The solution components can be protected for intellectual property purposes. An active component is employed for customization by the customer of the customer system.

These states are represented in rows of the multi-row base table. Thus, a transition to the system state is represented as system row. A transition to the system unpublish state, the system active state or system solution state is represented by the corresponding row after the system row inserted above.

A plus sign (+) indicates that there can be multiple rows associated with the state. For example, a plus sign next to system (that is, system+) represents that there is potentially multiple states (or rows) between the system row and the solution row. There can be a base row (which is the system row) that was created first. Then there could be a solution row followed by an active row and then finally another solution row, for example. Thus, the plus sign (+) represents all of the states between the first and a last row.

Moving from the nothing state to the system state and then to the system+solution state, the system is the base row and the solution is the top row, with anything inbetween. Note that there does not have to be anything inbetween, but there could potentially be multiple rows.

The transitions are called out on each one of the arrows. For example, going from the nothing state to the system state, a create operation is done which creates the system row. Then going from that system state to a system plus solution state can be done by performing an update on the system row while being in the context of a solution. Alternatively, a system customizer can create a new component which can be seen as moving from the nothing state to the active state, and any transition from there can be possible based on the arrows defined in the diagram.

More specifically, beginning at the nothing state 602, transitioning to a solution+state 604 can be via a create operation. Transition can then be to a solution+active state 606 via an update(sol) operation, and back to the solution+state 604 via one or more of a delete(sol), delete(act) and/or update(act) operations. The solution+active state 606 can then process the update(sol) and update(act) operations. Processing can transition from the solutions+state 604 to a solution+unpub state 608 via update(sol) or delete(sol) operations. Transitioning from the solution+unpub state 608 to the solution+state 604 can be using a delete(unpub), update(unpub), or publish operation. Flow from the solutions+unpub state 608 to the solution+active state 606 can be by delete(unpub) or publish operations. Flow from the solution+active state 606 can be by an update(act) or delete(act) operation. Flow from the solution+active state 606 to the solution+state 604 can be by delete(sol), delete(act), or update(act) operations. The solution+state 604 checks for update(sol) and delete(sol) processes, the solution+active state 606 checks for update(sol) and active(act) processes, and the solution+unpub state 608 checks for update(unpub) and update(sol) processes. Flow from the solution+state 604 back to the nothing state 602 is by a delete(sol) operation.

Moving to the active components, flow can be from the nothing state 602 to an active state 610 via a create operation, and to an unpub state 612 via a create operation. Flow from the active state 610 to an active unpub state 614 can be by delete(act) or update(act) operations. Flow can move from the active unpub state 614 back to the nothing state 602 using a publish operation. Flow can move from the active unpub state 614 to the active state 610 using publish or delete(unpub) operations. Flow from the active state 610 to the nothing state 602 can be performed using a delete(act) operation. Flow from the unpub state 612 to the active state 610 can be using a publish operation. Flow can be from the unpub state 612 back to the nothing state 602 using a delete(unpub) operation. The unpub state 612 checks for update(unpub) operations, the active state 6120 checks for update(act) operations, and the active unpub state 614 checks for update(unpub) operations.

FIG. 6B illustrates the system component portion of the state diagram 600. Flow from the nothing state 602 of FIG. 6A to a system state 616 of FIG. 6B can be by a create operation. Flow from the system state 616 to a system+unpub state 618 can be using delete(sys) or update(sys) operations. Flow back from the system+unpub state 618 to the system state 616 can be by publish or delete(unpub) operations. Flow from the system state 616 to a system+active state 620 can be via an update(sys) operation and back to the system state 616 using a delete(act) operation. Flow from the system state 616 to a system+solution state 622 can be via an update(sys) operation and back to the system state 616 using a delete(sol) operation.

Flow from the system+unpub state 618 to the system+active state 620 can be made using publish or delete(unpub) operations. Bi-directional flow between the system+active state 620 and the system+solution state 622 can be accomplished using delete(act), delete(sol), update(act), or update(sol) operations. Bi-directional flow between the system+solution state 622 and the system+unpub state 618 can be accomplished using delete(sol), update(sol), update(unpub), delete(unpub), and publish operations. The system state 616 checks for update(sys) operations, the system+unpub state 618 checks for update(unpub) operations, the system+active state 620 checks for update(act) operations, and the system+solution state 622 checks for update(sol) and delete(sol) operations. Flow from the system state 616 back to the nothing state 602 of FIG. 6A can be via a delete(sys) operation.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

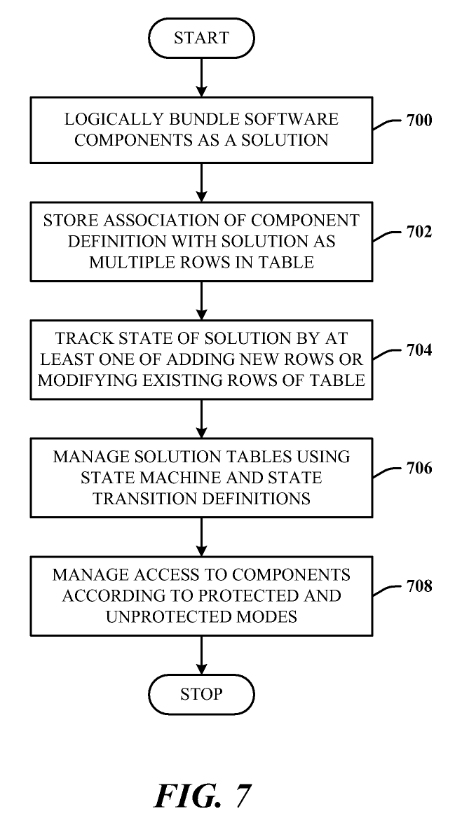

FIG. 7 illustrates a method of developing software solutions. At 700, software components are logically bundled as a solution. At 702, an association of a component definition with the solution is stored as multiple rows in a table. At 704, state of the solution is tracked by at least one of adding new rows or modifying existing rows in the table. At 706, solution tables are managed using a state machine and state transition definitions. At 708, access to the components is managed according to protected and unprotected modes.

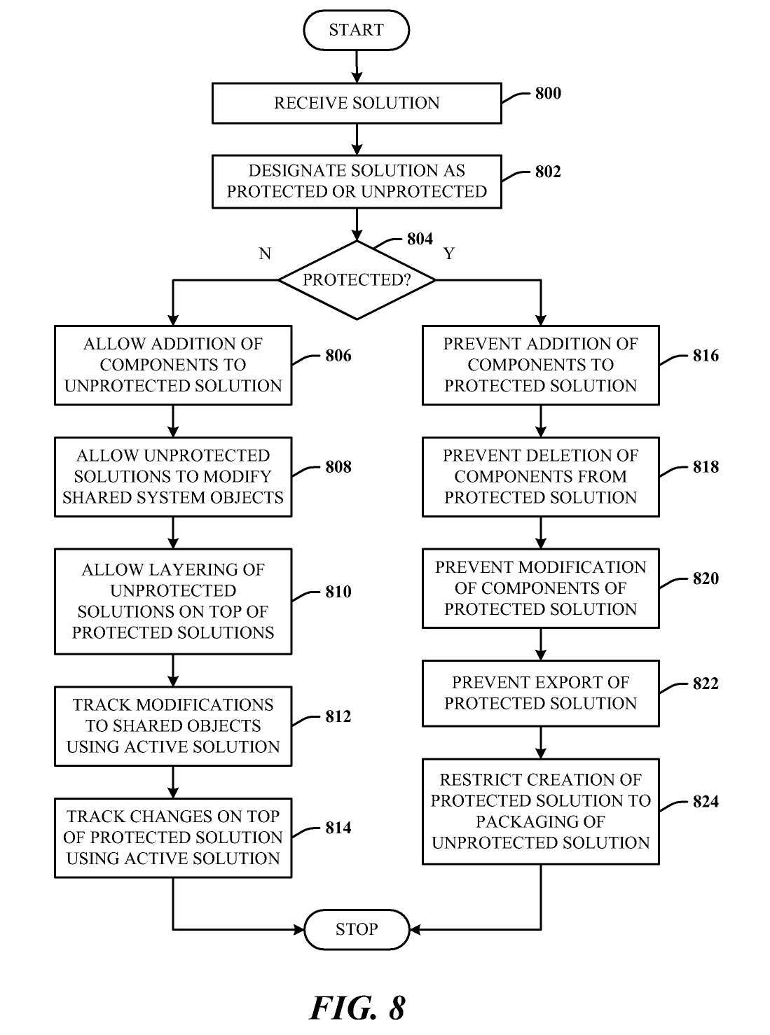

FIG. 8 illustrates a method of managing a solution. At 800, a solution is received. At 802, the solution is designated as protected or unprotected. At 804, based on the designation, flow can be to 806 for an unprotected solution. At 806, the addition of components to the solution is allowed. At 808, unprotected solutions are allowed to modify system objects. At 810, the layering of unprotected solution on top of protected solutions is allowed. At 812, modifications to the shared system objects are tracked using an active solution. At 814, changes made on top of the protected solution are tracked using the active solution.

Alternatively, at 804, based on the designation, flow can be to 816 for a protected solution. At 816, the addition of components to a protected solution is prevented. At 818, the deletion of components from the protected solution is prevented. At 820, modifications to the components of the protected solution are prevented. At 822, export of the protected solution is prevented. At 824, creation of the protected solution is restricted to packaging of an unprotected solution. Note that the preventative measures for the protected solution can be made selectively optional.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

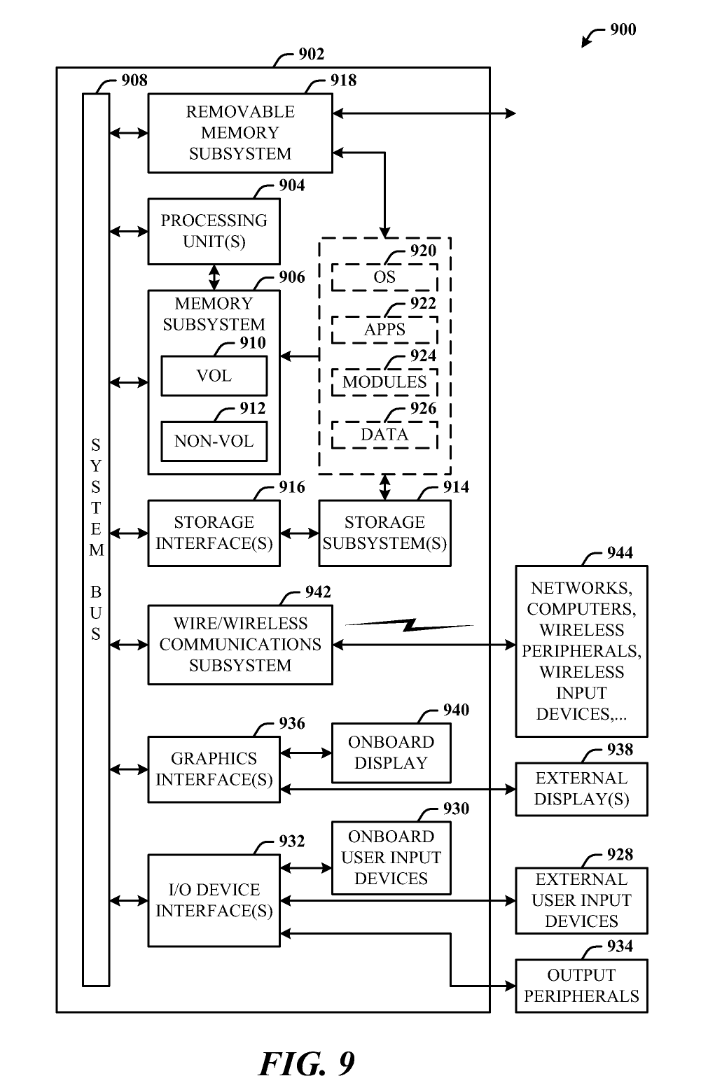

Referring now to FIG. 9, there is illustrated a block diagram of a computing system 900 operable to develop solutions and run solutions on a platform in accordance with the disclosed architecture. In order to provide additional context for various aspects thereof, FIG. 9 and the following discussion are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the memory subsystem 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes storage subsystem(s) 914 and storage interface(s) 916 for interfacing the storage subsystem(s) 914 to the system bus 908 and other desired computer components. The storage subsystem(s) 914 can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a removable memory subsystem 918 (e.g., flash drive form factor technology), and/or the storage subsystem(s) 914, including an operating system 920, one or more application programs 922, other program modules 924, and program data 926.

The one or more application programs 922, other program modules 924, and program data 926 can include the development environment 102 of FIG. 1, the flow and entities in the diagram 200, the architecture 300 of FIG. 3, the solutions diagram 400 of FIG. 4, the table 500 of multi-row entities of FIG. 5, the state machine exemplified by the state diagram 600 of FIGS. 6A and 6B, and the methods of FIGS. 7-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Computer readable media can be any available media that can be accessed by the computer 902 and includes volatile and non-volatile media, removable and non-removable media. For the computer 902, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP) using logical connections via a wire/wireless communications subsystem 942 to one or more networks and/or other computers. The other computers can include workstations, servers, routers, personal computers, microprocessor-based entertainment appliance, a peer device or other common network node, and typically include many or all of the elements described relative to the computer 902. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wire/wireless communication subsystem 942 (e.g., a network interface adapter, onboard transceiver subsystem, etc.) to communicate with wire/wireless networks, wire/wireless printers, wire/wireless input devices 944, and so on. The computer 902 can include a modem or has other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

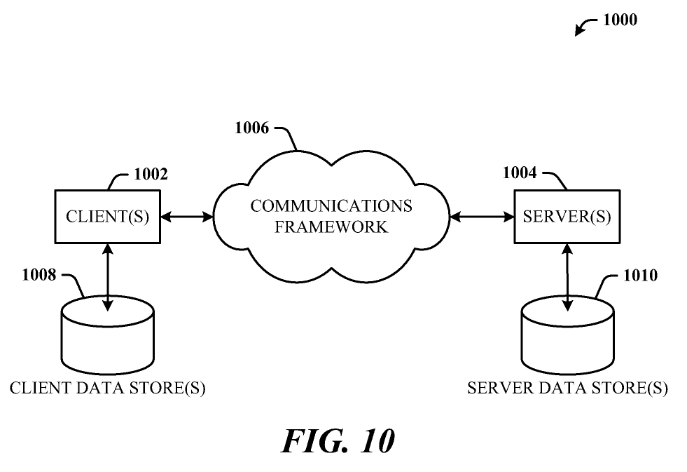

Referring now to FIG. 10, there is illustrated a schematic block diagram of a computing environment 1000 that facilitates solution development and operation on a platform. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented software solution development system, comprising:
a development environment for developing a software solution as a logical bundle of software components;
a storage component of the environment for storing an association of a component definition with the solution as multi-row entities; and
a transition management component of the environment for managing behavior changes in the software components based on state transition definitions.

2. The system of claim 1, wherein the storage component stores state of the components into multiple rows and tracks component modification by adding new rows or modifying existing rows.

3. The system of claim 1, wherein the storage component tracks root components of the solution in a master solutions table.

4. The system of claim 1, wherein the transition management component employs a state machine and state transition definitions to manage solution tables and modifies a transition definition in response to a change in behavior.

5. The system of claim 1, wherein the transition management component employs protected and unprotected logical modes for the solution.

6. The system of claim 1, wherein the development environment facilitates layering of an unprotected solution on top of a protected solution.

7. The system of claim 6, wherein the transition management component includes an active solution that tracks changes made to system objects and changes performed on top of protected solutions.

8. The system of claim 6, wherein the protected solution is prevented from being exported.

9. The system of claim 1, further comprising a transport component for exporting differences in modifications to a solution.

10. A computer-implemented software solution development system, comprising:
a development environment for developing a software solution as a logical bundle of software components, the solution employed in a protected mode or an unprotected mode;
a storage component of the environment for storing an association of a component definition with the solution as multi-row entities;
a transition management component of the environment for managing changes in behavior in the software components based on state transition definitions; and
a transport component for exporting differences in modifications to the solution and preventing a protected mode solution from being exported.

11. The system of claim 10, wherein the storage component stores state of the components into multiple rows and tracks modification to the components by adding new rows or modifying existing rows.

12. The system of claim 10, wherein the transition management component employs a state machine and state transition definitions to manage solution tables and facilitates modification of a transition definition in response to a change in the behavior.

13. The system of claim 10, wherein the development environment facilitates layering of an unprotected solution on top of a protected solution in a customer relationship management platform.

14. The system of claim 10, wherein the transition management component includes an active solution that tracks changes made to system objects and changes performed on top of protected solutions.

15. A computer-implemented method of developing software solutions, comprising:
logically bundling software components as a solution;
storing an association of a component definition with the solution as multiple rows in a table;
tracking state of the solution by at least one of adding new rows or modifying existing rows in the table;
managing solution tables using a state machine and state transition definitions; and
managing access to the components according to protected and unprotected modes.

16. The method of claim 15, further comprising developing the solution as protected or unprotected.

17. The method of claim 15, further comprising layering protected and unprotected solutions on top of a customer relationship management platform.

18. The method of claim 15, further comprising preventing export of a protected solution.

19. The method of claim 15, further comprising updating the solution via differences between the solution and an update to the solution.

20. The method of claim 15, further comprising building an unprotected solution on top of a protected solution.
